(19) United States
(12) Patent Application Publication
(10) Pub. No.: US 2011/0248136 A1
(43) Pub. Date: Oct. 13, 2011

(54) PROTRUDING POSITIONING PEDESTAL

(75) Inventor: Dong-Ming SHEN, SUZHOU (CN)

(73) Assignees: AU OPTRONICS CORPORATION, HSIN-CHU (TW); AU OPTRONICS (SUZHOU) CORP., LTD., SUZHOU (CN)

(21) Appl. No.: 12/873,331

(22) Filed: Sep. 1, 2010

(30) Foreign Application Priority Data
Apr. 8, 2010 (CN) 201010153161.6

(51) Int. Cl. F16M 13/02

(52) U.S. Cl. 248/300

(57) ABSTRACT

Disclosed herein is a protruding positioning pedestal having a bottom plate, a bent piece, a fastening component, and a fastening hole. The bent piece is cut from the bottom plate, bent up from the bottom plate, and extended toward the surface of the bottom plate, to form a positioning section and a prop section. The bent piece is upheld by the prop section on the bottom plate, and is buckled on the bottom plate by the fastening component and the fastening hole.

### RELATED APPLICATIONS

This application claims priority to Chinese Patent Application Number: 201010153161.6, filed on Apr. 8, 2010, which is herein incorporated by reference.

### BACKGROUND

1. Field of Invention

The present invention relates to a protruding positioning pedestal. In particular, the present invention relates to a protruding positioning pedestal on an electrical device back plate.

2. Description of Related Art

FIG. 1A illustrates an example of a conventional protruding pedestal on an electrical device back plate, which is a single protruding pedestal component 1 mounted on the electrical device back plate 2. Screws 12 are also used for screwing into the positioning holes 13 at two sides of the protruding pedestal component 1 to fasten the protruding pedestal component 1 on the back plate 2. Besides, a screw hole 11 should be disposed on the protrudent part of the protruding pedestal component 1 for fastening an external device. However, the manufacture of this kind of protruding pedestal does not only need to mount a protruding pedestal component 1 on a back plate 2, but also requires designing a specific mold for manufacturing the protruding pedestal component 1.

FIG. 1B illustrates another example of a conventional protruding pedestal on the electrical device back plate, which is a protruding pedestal 3 punched out from the surface of a back plate 4 by directly punching the back plate 4. And, a screw hole 31 is penetrated on the protrudent section of the protruding pedestal 3 for fastening an external device. However, the punch process of the back plate 4 may cause deformations of the back plate 4 due to different punching forces and punching positions.

Therefore, the technique of manufacturing a conventional protruding pedestal component on an electrical device back plate needs to be improved.

### SUMMARY

For this reason, the present invention provides a protruding positioning pedestal directly disposed on an electrical device back plate. According to an aspect of the present invention, a protruding positioning pedestal directly formed on the bottom plate includes a bent piece, a fastening component, and a fastening hole, wherein the bent piece is a strip plate which is incised from the bottom plate at the opening region and is connected to the bottom plate with a connecting end. The bent piece is bent at the connecting end and extended out from the bottom plate, thus forms an opening on the bottom plate whereof the bent piece is bent out. The bent piece is then bent opposite to the position of the opening and extended toward the upper surface of the bottom plate. And the bent piece is bent out to form a first bending section, a second bending section, and a third bending section. Between the first bending section and the second bending section of the bent piece is a positioning section, which extends over the upper surface of the bottom plate and extends parallel to the bottom plate, and between the third bending section and the cut end of the bent piece is a prop section which clings on the upper surface of the bottom plate. The fastening component sticks out of the upper surface of the bottom plate while the fastening hole is burrowed on the prop section surface facing to the bottom plate and aligned to the fastening component; or, the fastening component sticks out of the prop section surface facing to the bottom plate while the fastening hole is burrowed on the upper surface of the bottom plate and aligned to the fastening component. The fastening hole has an appropriate size to buckle the fastening component up such that the prop section of the bent piece can be fastened on the bottom plate.

According to another aspect of the present invention, a protruding positioning pedestal directly formed on the bottom plate includes a first bent piece, a second bent piece, a fastening component, and a fastening hole. The first bent piece is a strip plate incised from the bottom plate and is connected to the bottom plate with a first connecting end. The first bent piece is bent at the first connecting end and extended out from the bottom plate, and such that a first opening is formed on the bottom plate in the region where the first bent piece is bent. The first bent piece is bent opposite to the position of the first opening and extended toward the upper surface of the bottom plate. And the first bent piece bent out to form a first positioning section, which extends over the upper surface of the bottom plate and extends parallel to the bottom plate. The second bent piece is another strip plate which is incised from the bottom plate in a specific region with respect to the first bent piece and is connected to the bottom plate with a second connecting end. The second bent piece is bent at the second connecting end and extended out from the bottom plate such that a second opening is formed on the bottom plate in the region where the second bent piece is bent. The second bent piece is bent opposite to the position of the second opening and extended toward the upper surface of the bottom plate. And the second bent piece is bent out to form a second positioning section, which extends over the upper surface of the bottom plate and extends parallel to the bottom plate. The second positioning section and the first positioning section are superposed and clung together. The fastening component sticks out of the first positioning section surface facing to the second positioning section, while the fastening hole is burrowed on the second positioning section aligned to the fastening component; or, the fastening component sticks out of the second positioning section surface facing to the first positioning section, while the fastening hole is burrowed on the first positioning section aligned to the fastening component. The fastening hole has an appropriate size to buckle the fastening component up such that the first bent piece and the second bent piece can be fastened with each other

In summary, the present invention provides a protruding positioning pedestal, implementing the clinging of the bottom plate and the bent piece which is incised and bent out from the bottom plate to support each other, and implementing the fastening component and the fastening hole to constrain sliding. Therefore, the least elements are required to fasten a protruding positioning pedestal on a bottom plate, and thus prevent a protruding positioning pedestal from sliding or even deforming when screwing an external component onto it.

It is to be understood that both the foregoing general description and the following detailed description are by examples, and are intended to provide further explanation of the invention as claimed.

### BRIEF DESCRIPTION OF THE DRAWINGS

Embodiments of the invention will now be described by way of example only with reference to the accompanying drawings in which:

FIGS. 1A and 1B are illustrations of conventional positioning pedestals on an electronic device back plate;

FIG. 2 is a perspective view of the configuration of a protruding positioning pedestal of the present invention;

FIGS. 3A and 3B are illustrations of a first alternate embodiment of a protruding positioning pedestal of the present invention from two different viewpoints;

FIG. 4 is an illustration of a second alternate embodiment of a protruding positioning pedestal of the present invention;

FIG. 5 is an illustration of a third alternate embodiment of a protruding positioning pedestal of the present invention;

FIG. 6 is an illustration of a fourth alternate embodiment of a protruding positioning pedestal of the present invention; and

FIGS. 7A, 7B, 8A, 8B and 8C illustrate embodiments of configurations of a fastening component and a fastening hole of a protruding positioning pedestal of the present invention.

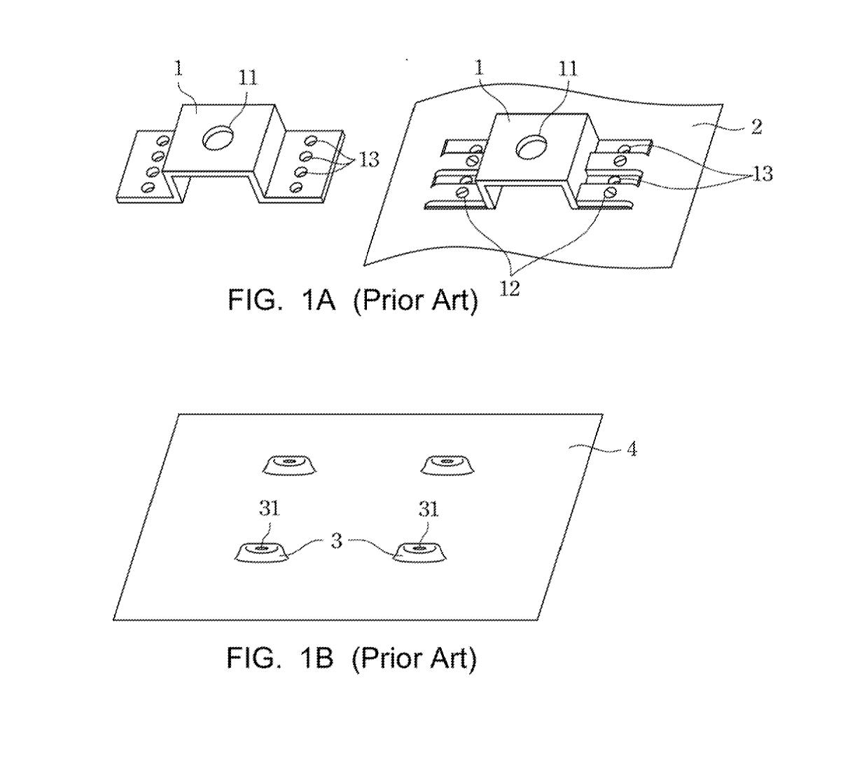

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

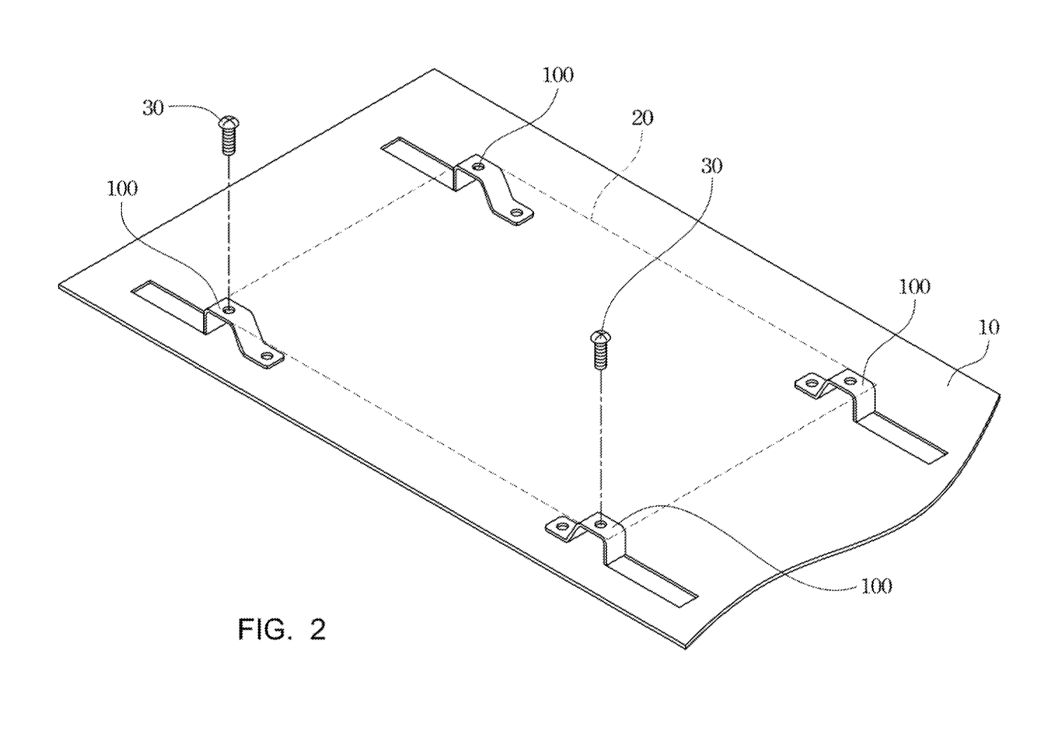

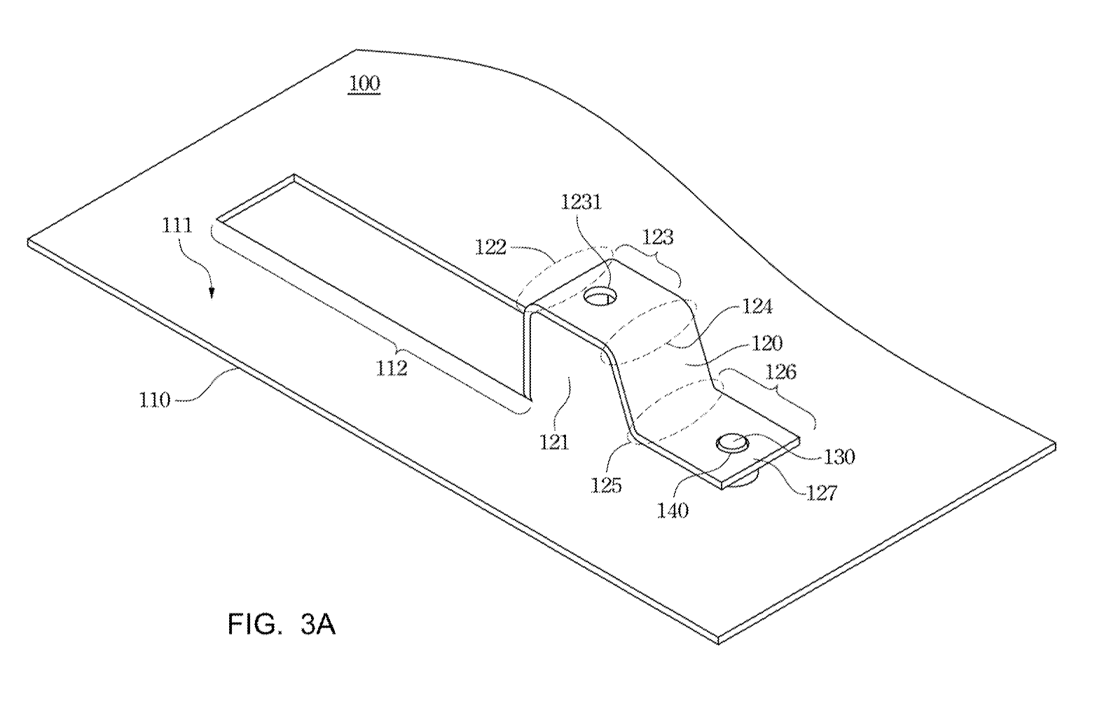

Refer to FIG. 2, which is a perspective view of the configuration of a protruding positioning pedestal of the present invention. The present invention provides a protruding positioning pedestal 100, disposed on an electrical device back plate 10 at the position with respect to a fasten screw 30 of an external component 20, for fastening the external component 20 on the electrical device back plate 10.

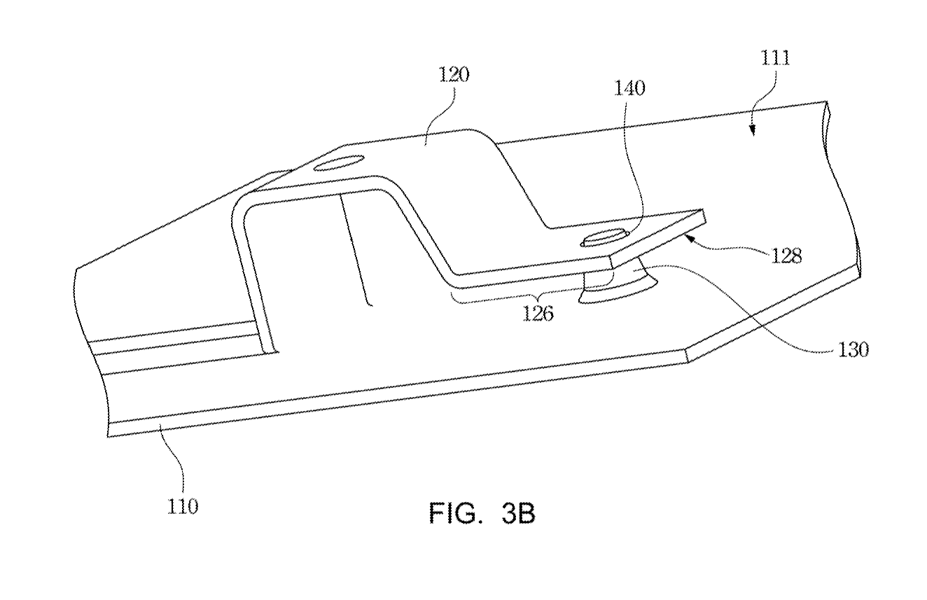

Refer to FIGS. 3A and 3B, which are illustrations of a first alternate embodiment of a protruding positioning pedestal of the present invention from two different viewpoints. The protruding positioning pedestal 100 of the present invention includes at least a bottom plate 110, a bent piece 120, a fastening component 130, and a fastening hole 140.

As shown in FIG. 3A, a bottom plate 110 has an upper surface 111, and the bent piece 120 is a strip plate which is incised from the bottom plate 110 in a specific region and is connected to the bottom plate 110 with a connecting end 121. The bent piece 120 is bent at the connecting end 121 and extended out from the bottom plate 110, thus forms an opening 112 on the bottom plate 110 whereof the bent piece 120 is incised and bent out. The bent piece 120 is then bent opposite to the position of the opening 112 and extended toward the upper surface 111. And the bent piece 120 is bent out to form a first bending section 122, a second bending section 124, and a third bending section 125. Between the first bending section 122 and the second bending section 124 of the bent piece 120 is a positioning section 123, which extends over the upper surface 111 and extends parallel to the bottom plate 110, while between the third bending section 125 and the cut end 127 of the bent piece 120 is a prop section 126 which clings on the upper surface 111 of the bottom plate 110. The above-mentioned positioning section 123 further includes a locking hole 1231 used for fastening an external component 20 (not shown in the figure).

As shown in FIG. 3B, a fastening component 130 is a protruding button sticking out of the upper surface 111, and a fastening hole 140 is formed on the surface 128 of the prop section 126 facing to the bottom plate 110, wherein the position of the fastening hole 140 is aligned to the fastening component 130. Therefore, the fastening hole 140 and the fastening component 130 can be buttoned to each other to constrain the lateral and vertical displacements of the prop section 126, thus the prop section 126 of the bent piece 120 is fastened on the bottom plate 110.

Accordingly, by means of connecting to the bottom plate 110 via the connecting end 121 of the bent piece 120, and the prop section 126 which displacement is constrained, the position of the protruding positioning pedestal 100 can be fixed on the bottom plate 110, such that the protruding positioning pedestal 100 does not slide laterally or even deform vertically caused by external forces when fastening an external component 20 (not shown in the figure). Thus the configuration of the protruding positioning pedestal of the present invention does not lead to the positioning inaccuracy.

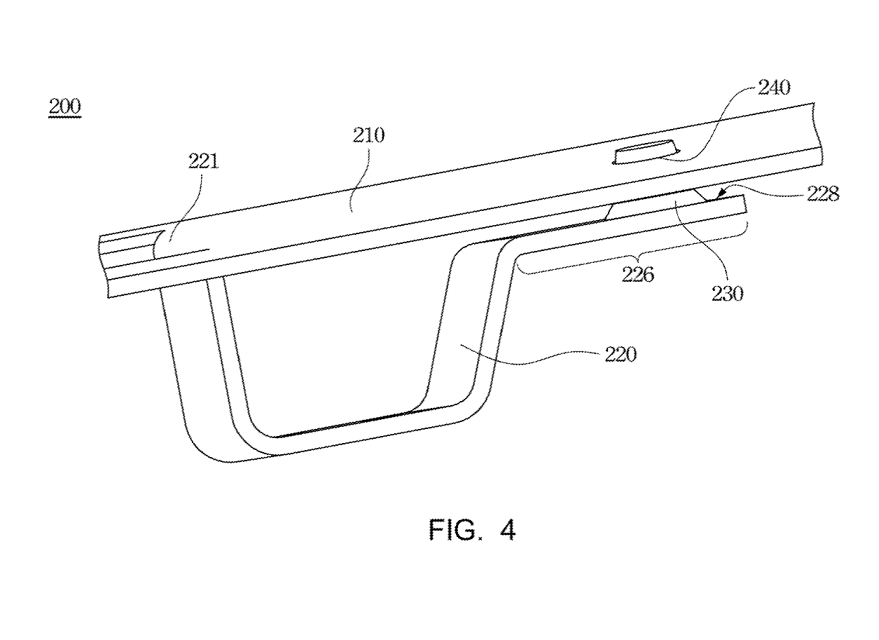

Refer to FIG. 4, which is an illustration of a second alternate embodiment of a protruding positioning pedestal of the present invention. The structures of the bottom plate 210 and the bent piece 220 of a protruding positioning pedestal 200 of the present invention are shown in the above-mentioned embodiment and corresponding figures, but are not limited to. The differences are that the fastening component 230 of the protruding positioning pedestal 200 of the second alternate embodiment is a protruding button sticking out the surface 228 of the prop section 226 facing to the bottom plate 210, while the fastening hole 240 is burrowed on the bottom plate 210 and at the position with respect to the fastening component 230. Therefore, the fastening hole 240 can be buttoned on the fastening component 230 to fasten the prop section 226 of the bent piece 220 on the bottom plate 210.

Accordingly, by means of connecting to the bottom plate 210 via the connecting end 221 of the bent piece 220, and the prop section 226 which displacement is constrained, the position of the protruding positioning pedestal 200 can be fixed on the bottom plate 210, such that the protruding positioning pedestal 200 does not slide or even deform caused by external forces.

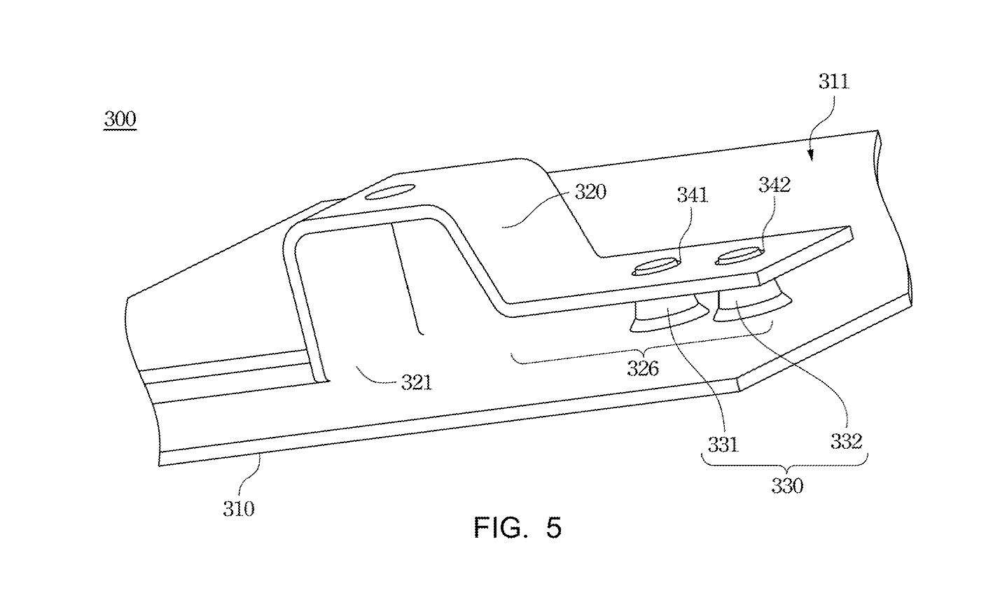

Refer to FIG. 5, which is an illustration of a third alternate embodiment of a protruding positioning pedestal of the present invention. The structures of the bottom plate 310 and the bent piece 320 of a protruding positioning pedestal 300 of the present invention are shown in the above-mentioned embodiment and corresponding figures, but are not limited to. The differences are that the fastening component 330 of the protruding positioning pedestal 300 of the third alternate embodiment the present invention are two protruding buttons 331 and 332 sticking out of the surface 311 of the bottom plate 310, and the two fastening holes 341 and 342 are burrowed on the prop section 326 of the bent piece 320 and at the positions with respect to the two protruding buttons 331 and 332. Therefore, the fastening holes 341 and 342 can be buttoned on the protruding buttons 331 and 332 to fasten the prop section 326 of the bent piece 320 on the bottom plate 310.

Accordingly, by means of connecting to the bottom plate 310 via the connecting end 321 of the bent piece 320 and the configuration of the two protruding buttons 331 and 332 and the two fastening holes 341 and 342, the constraint of the lateral and vertical displacement is enhanced, such that the position of the protruding positioning pedestal 300 is fixed on the bottom plate 310. Therefore, the protruding positioning pedestal 300 does not slide or even deform caused by external forces when fastening an external component 20 (not shown in the figure) Thus the configuration of the protruding positioning pedestal of the present invention does not lead to the positioning inaccuracy.

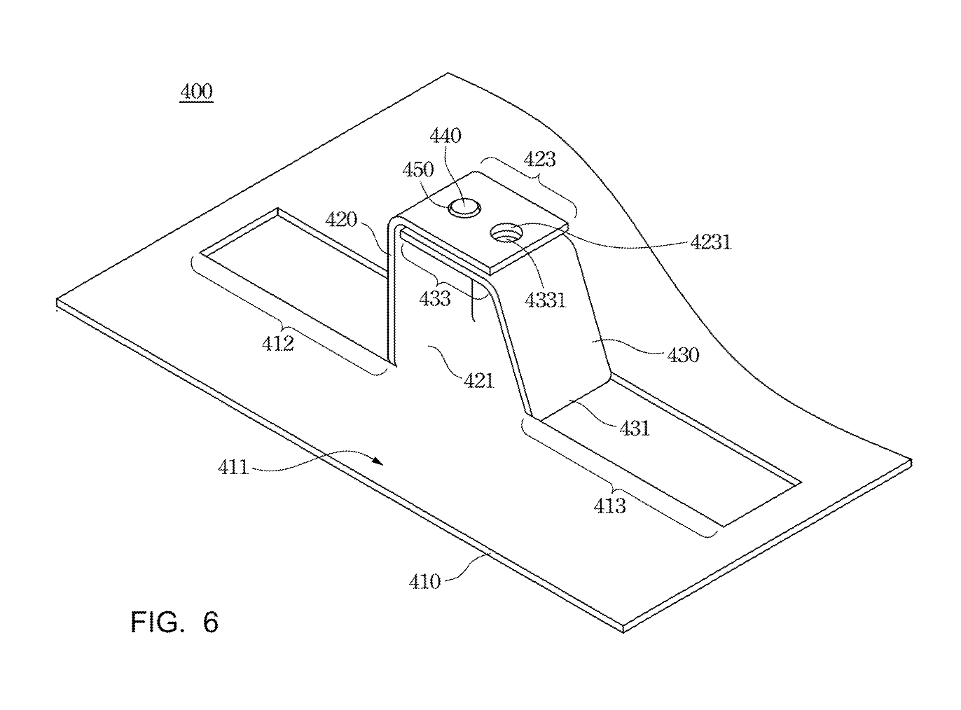

Refer to FIG. 6, which is an illustration of a fourth alternate embodiment of a protruding positioning pedestal of the present invention. The present invention provides a protruding positioning pedestal 400, including a bottom plate 410, a first bent piece 420, a second bent piece 430, a fastening component 440, and a fastening hole 450.

As shown in FIG. 6, the bottom plate 410 has an upper surface 411, where a first opening 412 and a second opening 413 are formed by incising the bottom plate 410.

The first bent piece 420 is a strip plate incised from the bottom plate 410 at a specific position and is connected to the bottom plate 410 with a first connecting end 421. The first bent piece 420 is bent at the first connecting end 421 and extended out from the bottom plate 410, and such that a first opening 412 is formed on the bottom plate 410 in the region where the first bent piece 420 is bent. The first bent piece 420 is then bent opposite to the position of the first opening 412 and extended toward the upper surface 411. And the first bent piece 420 is bent out to form a first positioning section 423, which extends over the upper surface 411 and extends parallel to the bottom plate 410.

The second bent piece 430 is another strip plate incised from the bottom plate 410 in the region with respect to the first bent piece 420 and is connected to the bottom plate 410 with a second connecting end 431. The second bent piece 430 is bent at the second connecting end 431 and extended out from the bottom plate 410 such that a second opening 413 is formed on the bottom plate 410 in the region where the second bent piece 430 is bent. The second bent piece 430 is then bent opposite to the position of the second opening 413 and extended toward the upper surface 411. And the second bent piece 430 is bent out to form a second positioning section 433, which extends over the upper surface 411 and extends parallel to the bottom plate 410. The second positioning section 433 and the first positioning section 423 are superposed and clung together. Moreover, the first positioning section 423 further includes a locking hole 4231, while the second positioning section 433 further includes a locking hole 4331, wherein the locking holes 4231 and 4331 are aligned together for fastening an external component 20 (not shown in the figure).

The fastening component 440 is a protruding button sticking out of the second positioning section 433 facing to the first positioning section 423. And, the fastening hole 450 is burrowed on the first positioning section 423 and at the position aligning to the fastening component 440. The fastening hole 450 can buckle the fastening component 440 up such that the first bent piece 420 and the second bent piece 430 can be fastened with each other to form a protruding positioning pedestal 400 protruding on the bottom plate 410.

Vice versa, regarding the fastening component 440 and the fastening hole 450 of the present invention, it is substitutable that the fastening component 440 is a protruding button sticking out of the first positioning section 423 facing to the second positioning section 433, and the fastening hole 450 is burrowed on the second positioning section 433 and at the position aligning to the fastening component 440. Such that the first bent piece 420 and the second bent piece 430 can be fastened with each other to form a protruding positioning pedestal 400 protruding on the bottom plate 410.

Accordingly, by means of connecting to the bottom plate 410 via the first connecting end 421 of the first bent piece 420 and via the second connecting end 431 of the second bent piece 430, and by means of clinging to each other via the first positioning section 423 and the second positioning section 433 which displacement are constrained by the fastening hole 450 buckled on the fastening component 440, the position of the protruding positioning pedestal 400 on the bottom plate 410 is fixed. Therefore, the protruding positioning pedestal 400 does not slide or even deform caused by external forces.

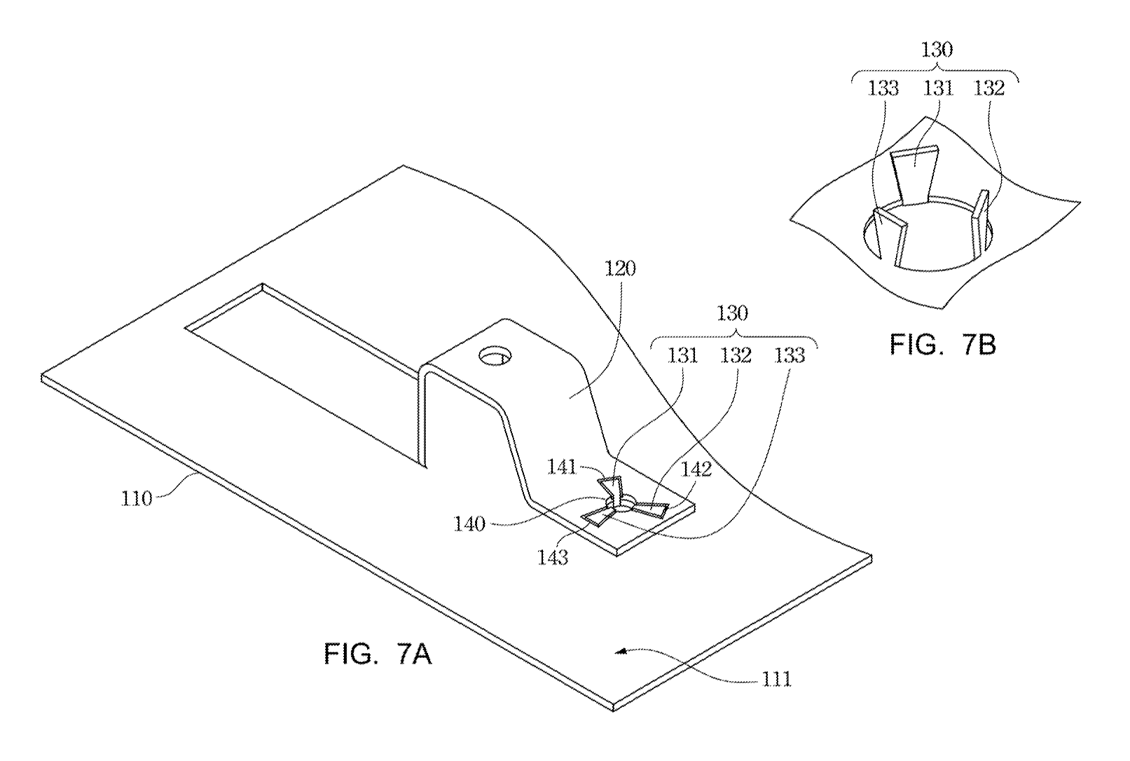

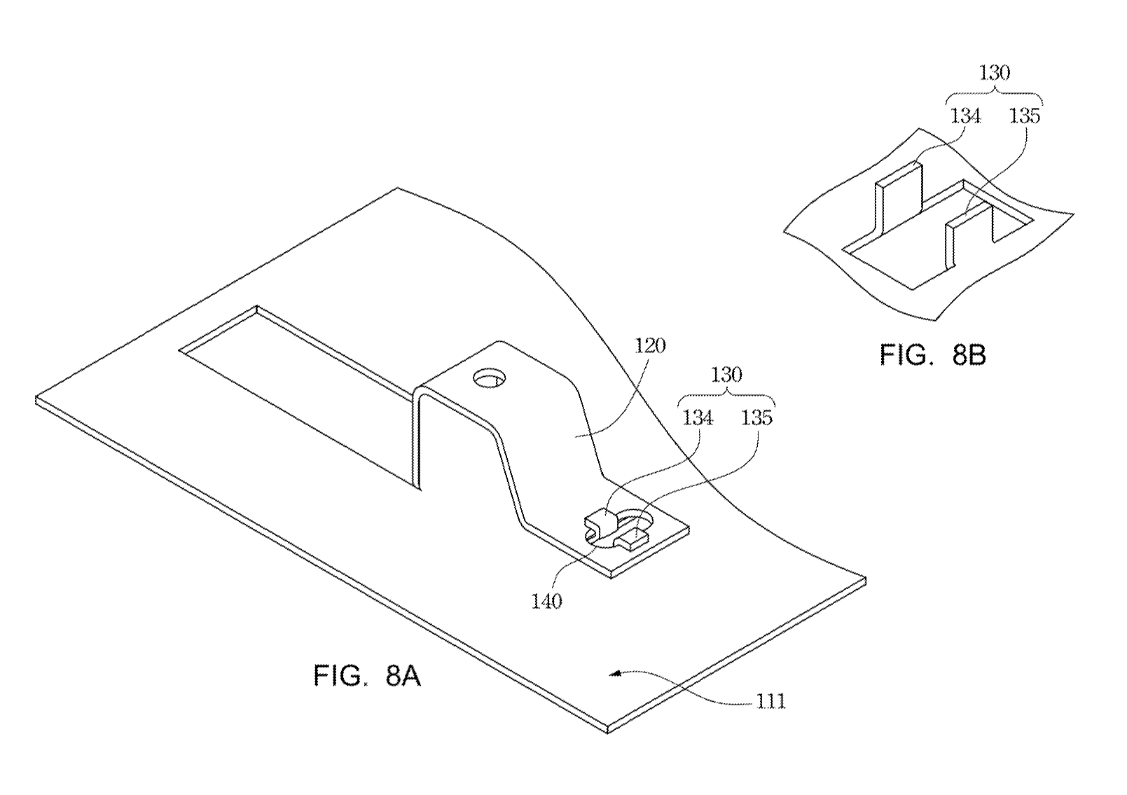

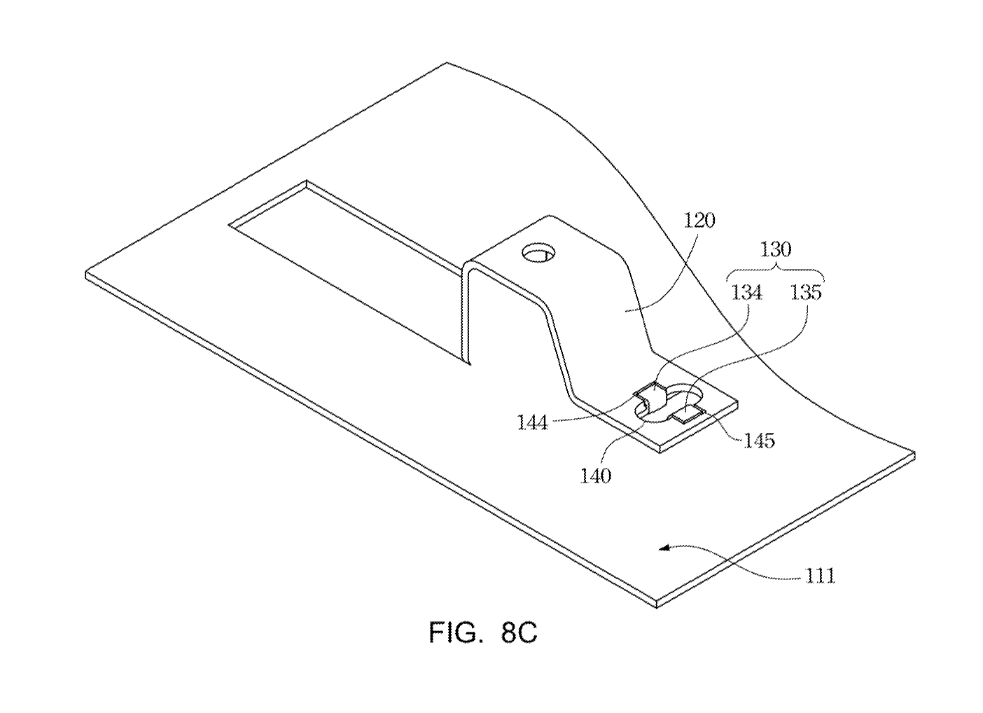

Refer to FIGS. 7A, 7B, 8A, 8B, and 8C, which illustrate embodiments of configurations of a fastening component and a fastening hole of a protruding positioning pedestal of the present invention. Due to the relative positions and structures of a bent piece and a bottom plate of the protruding positioning pedestal of the present invention are of the same concept, a first alternate embodiment recited in FIG. 3 is used to describe, but are not limited to, a fastening component and a fastening hole of the present invention.

As shown in FIG. 7A, the fastening component 130 sticking out of the upper surface 111 of the bottom plate 110 of the first alternate embodiment of the present invention is a plurality of flaps 131-133 (as shown in FIG. 7B), which are incised from the bottom plate 110 and then bent over to protrude the upper surface 111 of the bottom plate 110. The flaps 131-133 can be perforated through the fastening hole 140 of the bent piece 120 and folded onto the periphery of the fastening hole 140. Moreover, the periphery of the fastening hole 140 further includes a plurality of inlay grooves 141-143 with respect to the flaps 131-133, for containing folded flaps 131-133, which are folded onto the periphery of the fastening hole 140.

As shown in FIG. 8A, the fastening component 130 sticking out of the upper surface 111 of the bottom plate 110 of the first alternate embodiment of the present invention are two flaps 134 and 135 (as shown in FIG. 8B), which are incised from the bottom plate 110 and then bent over to protrude the upper surface 111 of the bottom plate 110. The two flaps 134 and 135 can be perforated through the fastening hole 140 of the bent piece 120 and folded onto the periphery of the fastening hole 140. Moreover, as shown in FIG. 8C, the periphery of the fastening hole 140 further includes a plurality of inlay grooves 144 and 145 with respect to the flaps 134 and 135, for containing folded flaps 134 and 135, which are folded onto the periphery of the fastening hole 140.

As the same reason stated above, taking a second alternate embodiment recited in FIG. 4 as an example, the fastening component 230 are a plurality of flaps, which are incised from the prop section 226 of the bent piece 220 and then bent over to protrude the prop section 226 of the bent piece 220. These flaps can be perforated through the fastening hole 240 and folded onto the periphery of the fastening hole 240. Taking a fourth alternate embodiment recited in FIG. 6 as an example, the fastening component 440 are a plurality of flaps, which are incised from the prop section 433 of the second bent piece 430 and then bent over to protrude the prop section 433 of the second bent piece 430. These flaps can be perforated through the fastening hole 450 of the first bent piece 420 and folded onto the periphery of the fastening hole 450.

Accordingly to the protruding positioning pedestal of the present invention, by means of clinging and propping to each other via the bottom plate and the bent piece incised and bent over therefrom, and by implementing the fastening hole and the fastening component to constrain the displacement of the bent piece, the least elements are required to fasten a protruding positioning pedestal on a bottom plate. And thus a protruding positioning pedestal is prevented from sliding or even deforming when screwing an external component onto it.

It is to be understood that the claims are not limited to the precise configuration and components illustrated above. Various modifications, changes and variations may be made in the arrangement, operation and details of the methods and apparatus described above without departing from the scope of the claims. While the foregoing is directed to aspects of the present disclosure, other and further aspects of the disclosure may be devised without departing from the basic scope thereof, and the scope thereof is determined by the claims that follow.

What is claimed is:

1. A protruding positioning pedestal, comprising:
a bottom plate having an upper surface, wherein the upper surface has an opening formed by incising the bottom plate;
a bent piece being a strip plate which is incised from the bottom plate at the opening region and connected to the bottom plate with a connecting end, wherein the bent piece, bent at the connecting end and extended out from the bottom plate, is sequentially bent out to form a positioning section and a prop section, wherein the positioning section located between a first bending section and a second bending section extends over the upper surface and extends parallel to the bottom plate, while the prop section located between a third bending section and a cut end of the bent piece clings on the upper surface;
a fastening component either sticking out of the upper surface, or sticking out of the prop section surface facing to the bottom plate; and
a fastening hole being aligned to the fastening component and burrowed on the other surface with respect to the surface on which the fastening component is disposed, wherein the fastening hole is used for buckling the fastening component to fasten the prop section of the bent piece onto the bottom plate.

2. The protruding positioning pedestal of claim 1, wherein the bent piece is bent in a direction opposite to the opening and extends toward the upper surface.

3. The protruding positioning pedestal of claim 1, wherein the fastening component is a protruding button.

4. The protruding positioning pedestal of claim 1, wherein the fastening component, which sticks out of the upper surface, comprises a plurality of flaps incised from the bottom plate and folded therefrom.

5. The protruding positioning pedestal of claim 4, wherein the flaps are perforated through the fastening hole and folded onto the periphery of the fastening hole.

6. The protruding positioning pedestal of claim 5, wherein the periphery of the fastening hole further comprises a plurality of inlay grooves for containing the folded flaps, which are folded onto the periphery of the fastening hole.

7. The protruding positioning pedestal of claim 1, wherein the fastening component, which sticks out of the prop section and extends toward the surface of the bottom plate, comprises a plurality of flaps incised from the prop section of the bent piece and folded therefrom.

8. The protruding positioning pedestal of claim 7, wherein the flaps are perforated through the fastening hole and folded onto the periphery of the fastening hole.

9. The protruding positioning pedestal of claim 8, wherein the periphery of the fastening hole further comprises a plurality of inlay grooves for containing the folded flaps, which are folded onto the periphery of the fastening hole.

10. The protruding positioning pedestal of claim 1, wherein the positioning section further comprises a locking hole for fastening an external component.

11. A protruding positioning pedestal, comprising:
a bottom plate having an upper surface, wherein the upper surface has a first opening and a second opening formed by incising the bottom plate;
a first bent piece being a strip plate which is incised from the bottom plate at the first opening region and connected to the bottom plate with a first connecting end, wherein the first bent piece, bent opposite to the position of the first opening and extended toward the upper surface, is bent at the first connecting end and extended out from the bottom plate and is bent out to form a first positioning section, which extends over the upper surface and extends parallel to the bottom plate;
a second bent piece being another strip plate which is incised from the bottom plate at the second opening region and connected to the bottom plate with a second connecting end, wherein the second bent piece, bent opposite to the position of the second opening and extended toward the upper surface, is bent at the second connecting end and extended out from the bottom plate and is bent out to form a second positioning section, which extends over the upper surface and extends parallel to the bottom plate, wherein the second positioning section and the first positioning section are superposed together;
a fastening component either sticking out of the first positioning section surface facing to the second positioning section, or sticking out of the second positioning section surface facing to the first positioning section; and
a fastening hole being aligned to the fastening component and burrowed on the other surface with respect to the surface on which the fastening component is disposed, wherein the fastening hole is used for buckling the fastening component to fasten the first bent piece and the second bent piece with each other.

12. The protruding positioning pedestal of claim 11, wherein the fastening component is a protruding button.

13. The protruding positioning pedestal of claim 11, wherein the fastening component, which sticks out of the first positioning section, comprises a plurality of flaps incised from the first positioning section of the first bent piece and bent out from the first positioning section.

14. The protruding positioning pedestal of claim 13, wherein the flaps are perforated through the fastening hole and folded onto the periphery of the fastening hole.

15. The protruding positioning pedestal of claim 14, wherein the periphery of the fastening hole further comprises a plurality of inlay grooves for containing the folded flaps, which are folded onto the periphery of the fastening hole.

16. The protruding positioning pedestal of claim 11, wherein the fastening component, which sticks out of the second positioning section, comprises a plurality of flaps incised from the second positioning section of the second bent piece and bent out from the second positioning section.

17. The protruding positioning pedestal of claim 16, wherein the flaps are perforated through the fastening hole and folded onto the periphery of the fastening hole.

18. The protruding positioning pedestal of claim 17, wherein the periphery of the fastening hole further comprises a plurality of inlay grooves for containing the folded flaps, which are folded onto the periphery of the fastening hole.

19. The protruding positioning pedestal of claim 11, wherein the positioning section further comprises a locking hole for fastening an external component.
